(19) United States
(12) Patent Application Publication
(10) Pub. No.: US 2012/0107768 A1
(43) Pub. Date: May 3, 2012

(54) DENTAL PROTECTIVE DEVICE AND METHOD OF USE

(76) Inventor: William A. DiEdwardo, Fort Lauderdale, FL (US)

(21) Appl. No.: 13/278,336

(22) Filed: Oct. 21, 2011

Related U.S. Application Data
(60) Provisional application No. 61/455,912, filed on Oct. 29, 2010.

(51) Int. Cl. A61C 5/14

(52) U.S. Cl. 433/136; 433/217.1

(57) ABSTRACT

The present invention relates generally to the protection of a wearer of an installed dental appliance, such as braces, against pain, discomfort and injury due to the lips, cheek and tongue of the wearer rubbing against a rough or sharp edge of the braces. A dental protective device is used for protection against this discomfort and injury from the braces. The dental protective device is a moisture-activated self-adhering protective strip loosely adhered to a backing strip and packaged in a sealed foil pouch. In use, the protective strip is peeled away from the backing and applied to an area in need of protection.

### CROSS-REFERENCE TO RELATED APPLICATIONS

This application claims the benefit of U.S. provisional application No. 61/455,912 filed Oct. 29, 2010, the disclosure of which is incorporated herein by reference.

### FIELD OF THE INVENTION

The present invention relates generally to a dental protective device. One embodiment of the invention relates to the dental protective device configured to protect a user's lips, tongue and cheek from injury due to rubbing against an installed dental appliance, such as orthodontic braces. The dental protective device of the present invention may also be configured to protect a user's lips, tongue and cheek from injury due to rubbing against other dental appliances, such as orthodontic retainers, or other dental appliances, such as bridges, or partials.

### BACKGROUND

Dental braces are used to straighten and align teeth. Dental braces, or “braces” mainly consist of metal brackets installed around each tooth and an arch wire connecting the teeth of each jaw. The teeth move when the arch wire applies force to the brackets and teeth. Sometimes, springs or rubber bands are used to put additional force in a specific direction and location. When braces are installed, the braces often create pain, discomfort and injury due to the lips, tongue and the inside of the cheek moving relative to rough and sharp edges of the braces.

Traditionally, dental wax has been utilized to protect the lips, inside cheek and gums from the rough and sharp edges of the braces. Dental wax may offer effective protection, but it has its' drawbacks. One drawback is that the dental wax must be rolled-up into a ball to apply to the target area. Once the rolled-up ball of wax is applied to the target area of the braces, it must be shaped to the right final configuration inside the mouth. This can be a time-consuming and frustrating process. If this process not done accurately, the dental wax will not afford proper protection from pain, discomfort and injury. Another drawback of using dental wax is that for dental wax to be effective, the wax must be applied with the correct pressure. Too much pressure and the wax is susceptible to becoming lodged in areas between the teeth and braces, making removal difficult. Too little pressure, and the wax quickly falls-off. Even with the correct amount of pressure, the wax generally remains in place for only a few hours and may fall-off if food or drink is consumed.

Due to the above mentioned problems with the use of dental wax, other solutions to the use of wax have been utilized in the past, with mixed success. One solution was the use of plastic shields, which resemble sport mouth guards. While these plastic shields may offer effective protection from the pain and discomfort of the braces, they are bulky and may be uncomfortable and unsightly to wear. The plastic shields may also interfere with the ability to speak clearly. Another solution was the use of a different type of plastic shield, one in which the shield clips-on directly to the arch wire of the braces. While in some ways an improvement over the above plastic shield, this clip-on plastic shield has disadvantages in that it is still relatively bulky and is designed to be used over several teeth, when only one localized area is in need of shielding. Additionally, clip-on shields are not efficient when orthodontic braces are not in a straight line, or are offset. In this instance, separate shields may be required on each side of the offset. Both plastic shields have the disadvantages of having to be cleaned before reuse, potentially compromising oral hygiene and being relatively expensive, as the shields may require a custom fit to the user.

An additional solution was the use of wax impregnated cloth. While the wax impregnated cloth overcomes some of the disadvantages of the plastic shields, the wax impregnated cloth retains some of the disadvantages of the use of wax alone. These disadvantages include having to mold the wax impregnated cloth around the braces such that there is adequate protection, without being too bulky. As with wax alone, molding the wax impregnated cloth into shape may likely be a tedious and frustrating process. Additionally, the wax impregnated cloth may require heating to become fully pliable.

A further solution was proposed in which thermoplastic material is preformed in the shape of a strip and allowed to cool. For a custom fit, the wearer heats-up the thermoplastic strip and then applies the strip to the area being protected. The heated strip is applied to the area being protected and allowed to cool, thereby creating the custom-fit protective strip. This further solution has the disadvantage of being time-consuming to form and also presents oral hygiene problems by having to reapply a non-hygienic strip, thoroughly cleaning the strip after each use, or repeatedly shaping a new heated strip to the area being protected.

For the above reasons, there is a need for a dental protective device which overcomes the above drawbacks. This dental protective device overcomes the above drawbacks by being inexpensive, by facilitating oral hygiene by being disposable and preventing most foods from lodging under braces, by not being bulky, by one size being usable in all applications, by not facilitating unwanted moisture, or saliva formulation, by being quick and easy to apply and by not interfering with speaking, drinking or eating.

### SUMMARY OF THE INVENTION

The present invention is directed toward an improved dental protective device capable of overcoming the above drawbacks. The dental protective device of the present invention is configured as a moisture-activated self-adhering protective strip loosely adhered to a backing strip and packaged in a sealed foil pouch. The dental protective device is disposable. The dental protective device may be marketed in packaging containing multiple protective strips. The dental protective device is latex-free.

In use, the protective strip is peeled away from the backing and installed to the localized area in need of protection. The thickness of the protective strip is such that the strip provides protection without being bulky. If desired, the protective strip may be trimmed before application to facilitate installation. The protective strip may be worn as long as needed. When installed properly, the protective strip is safe to use while sleeping and while consuming most food and beverage. When installed properly, the protective strip protects the lips, inside cheek and gums from rough and sharp edges of the braces. The protective strip only need be removed when brushing, as micro-particles of food may be present under the edges of the protective strip.

An embodiment of the present invention may include the protective strip being clear, or tooth enamel colored. An embodiment of the present invention may include the protective strip being flavored, such as mint flavored. An embodiment of the present invention may include the protective strip being infused with medication, or antibiotics.

An embodiment of the present invention may include the protective strip being manufactured of some, or all of Carbomer 980, Hydroxyethyl Celluose (HEC), Sorbitol, Polyvinylpyrolidone (PVP), Polyethylene and Polypropylene, Acrylates Copolymer, flavoring, such as mint and water.

An embodiment of the present invention may include these and other features, aspects, and advantages of the present invention will become better understood with regard to the following description, appended claims, and accompanying drawings.

### DRAWINGS

FIG. 1A illustrates the dental protective device supplied in a sealed foil pouch.

FIG. 1B shows a plan view of the dental protective device.

FIG. 2A illustrates the protective strip of the dental protective device ready to be installed on a desired area of a wearer's teeth and braces. FIG. 2B illustrates the protective strip of the dental protective device beginning to be installed on the desired area of a wearer's teeth and braces. FIG. 2C illustrates the protective strip of the dental protective device undergoing final installation on a wearer's teeth and braces.

FIG. 3 illustrates a method of using the dental protective device.

### DETAILED DESCRIPTION

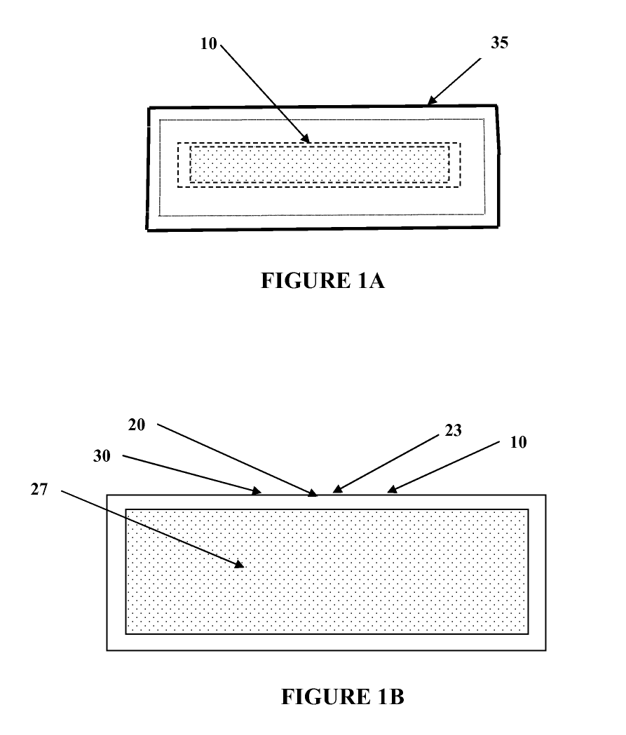

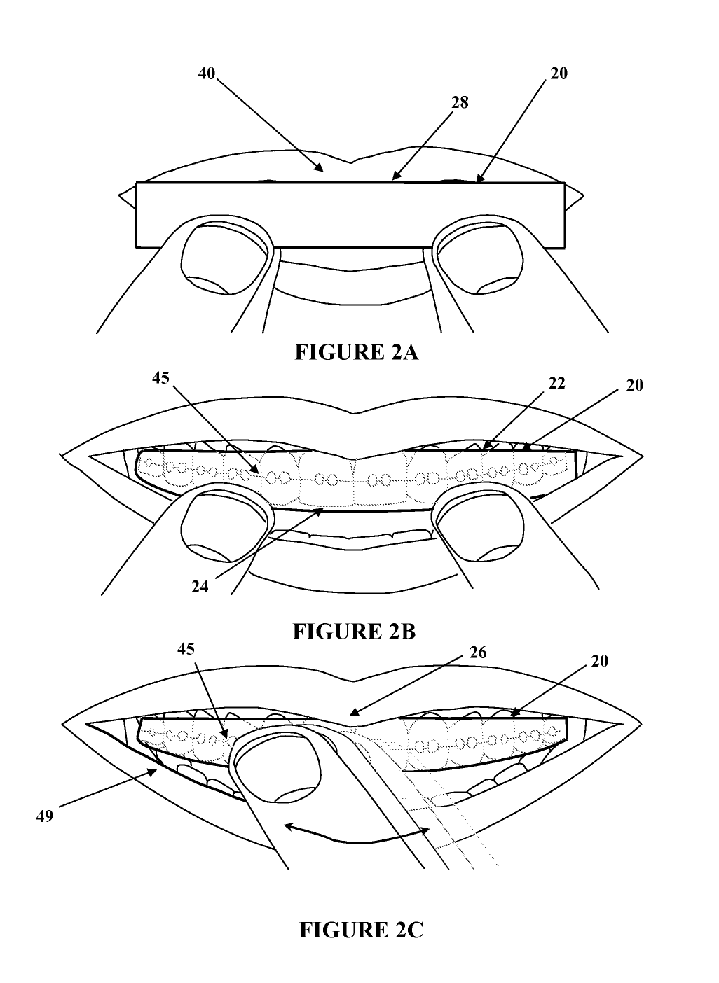

As illustrated on FIGS. 1A and 1B, an embodiment of the present invention is directed toward the dental protective device 10. The dental protective device 10 is utilized to protect against unwanted pain, discomfort and injury in the oral cavity from an installed dental appliance, such as orthodontic braces 45 (FIGS. 2B and 2C). The dental protective device 10 consists of a protective strip 20 and a backing strip 30 loosely adhered to the protective strip 20 on a dental appliance contacting side 28 (FIG. 2A). The backing strip 30 is of a larger area than the protective strip 20 when viewed from above, to facilitate easy removal of the protective strip 20 from the backing strip 30. The protective strip 20 is configured as a base material 23 coated with water soluble adhesive 27 on the dental appliance contacting side 28 of the protective strip 20. To ensure proper oral hygiene, the dental protective device 10 is supplied in a sealed foil pouch 35.

In one embodiment of the invention, the protective strip 20 base material 23 may be polyethylene. In one embodiment of the invention, the backing strip 30 material may be polypropylene. In one embodiment of the invention, the water soluble adhesive 27 composition may include Carbomer 980, Hydroxyethyl Celluose (HEC), Sorbitol, Polyvinylpyrrolidone (PVP), Acrylates Copolymer, water and a flavoring, such as mint.

As illustrated on FIGS. 2A-2C, in use, the protective strip 20 is installed on the desired area 40 in need of protection. The protective strip 20 and loosely adhered backing strip 30 may be trimmed to size with scissors if the desired area 40 in need of protection is small. Just before applying the protective strip 20, the teeth and mouth areas of a wearer of the protective strip 20 are moistened. After any desired trimming, the backing strip 30 is peeled away from the protective strip 20 and discarded. The protective strip 20 is then grasped between fingers of the wearer of the protective strip 20. As illustrated on FIG. 2A, the protective strip 20 is then inserted into the mouth of the wearer and directed to the desired area 40 needing protection. As illustrated on FIG. 2B, a first edge 22 of the protective strip 20 is then applied to the gum line of the desired area 40 needing protection. The protective strip 20 is then applied over the desired area 40 of the braces 45 needing protection. Finally, as illustrated on FIG. 2C, the protective strip 20 is wrapped over a second edge 24 and a back portion 26 of the desired area 40 needing protection. After application, to insure proper adhesion, and to reduce size, the protective strip 20 is then rubbed with the wearers' fingers, particularly proximal the braces 45 and at the edges of the protective strip 20 such that the protective strip 20 is firmly adhered the braces 45 and proximal areas of the teeth. At this time, the protective strip has been installed to the installed position 49.

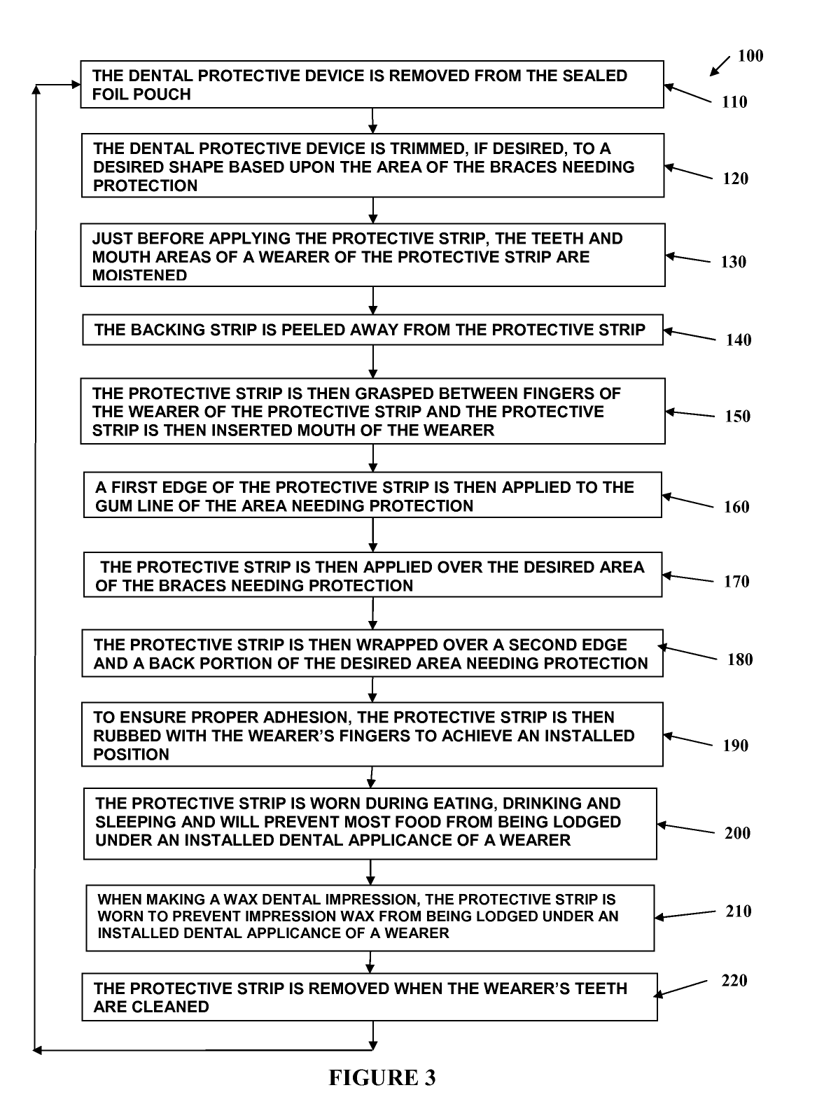

FIG. 3 illustrates a method 100 of use of the dental protective device 10. In step 110, the dental protective device 10 is removed from the sealed foil pouch 35. In step 120, the dental protective device 10 is trimmed, if desired, to a desired shape based upon the desired area 40 of the braces 45 needing protection. The trimming should be limited so as to still include adequate surface area for adhesion of the protective strip 20 to the desired area 40 of the braces 45 needing protection. In step 130, just before applying the protective strip 20, the teeth and mouth areas of a wearer of the protective strip 20 are moistened to facilitate adhesion of the water soluble adhesive 27 on the contacting side 28 of the protective strip 20. In step 140, the backing strip 30 is peeled away from the protective strip 20. In step 150, the protective strip 20 is grasped between fingers of the wearer of the protective strip 20 and the protective strip 20 is inserted into the mouth of the wearer of the protective strip 20. In step 160, a first edge 22 of the protective strip 20 is then applied to the gum line proximal the desired area 40 needing protection. In step 170, the protective strip 20 is then applied over the desired area 40 of the braces 45. In step 180, the protective strip 20 is then wrapped over the second edge 24 and the back portion 26 of the desired area 40 needing protection. In step 190, to ensure proper adhesion of the water soluble adhesive 27, and to reduce the size of the installed protective strip 20, the protective strip 20 is then rubbed with the wearer's fingers, particularly proximal the braces 45 and at edges of the protective strip 20 to achieve the installed position 49. In step 200, the protective strip is worn during eating, drinking and sleeping and will prevent most food from being lodged under braces 45. In step 210, when a wax dental impression is being made of the wearer's teeth, the protective strip 20 is worn to prevent dental prevention wax from being lodged under a wearer's teeth, which saves time for an orthodontist, or dentist. In step 220, the protective strip 20 is removed when the wearer's teeth are cleaned and a new protective strip 20 is installed after cleaning.

Although the present invention has been described in considerable detail with references to certain preferred versions thereof, other versions are possible. Therefore, the spirit and scope of the appended claims should not be limited to the description of the preferred version contained herein.

What is claimed is:

1. A dental protective device comprising:
a protective strip, the protective strip configured as a base material coated with a water soluble adhesive coating on a dental appliance contacting side of the protective strip,
a backing strip loosely adhered to the dental appliance contacting side of the protective strip,
wherein the protective strip is capable of adhering to an installed dental appliance by the water soluble adhesive being exposed to moisture.

2. The dental protective device of claim 1, wherein the installed dental appliance is orthodontic braces.

3. The dental protective device of claim 1, wherein the protective strip base material is polyethylene.

4. The dental protective device of claim 1, wherein the backing strip material is polypropylene.

5. The dental protective device of claim 1, wherein the water soluble adhesive coating is composed of materials including Carbomer 980, Hydroxyethyl Celluose (HEC), Sorbitol, Polyvinylpyrrolidone (PVP), Acrylates Copolymer, water and flavoring.

6. The dental protective device of claim 1, wherein the protective strip base material is polyethylene the backing strip material is polypropylene.

7. The dental protective device of claim 1, wherein the protective strip base material is polyethylene the backing strip material is polypropylene and the water soluble adhesive composition includes Carbomer 980, Hydroxyethyl Celluose (HEC), Sorbitol, Polyvinylpyrrolidone (PVP), Acrylates Copolymer, water and mint flavoring.

8. The dental protective device of claim 1, wherein the backing strip is of a larger area than the protective strip when viewed from above.

9. The dental protective device of claim 1, wherein the dental protective device is supplied in a sealed foil pouch.

10. The dental protective device of claim 1, wherein the protective strip is capable of remaining adhered to the installed dental appliance while eating, drinking and sleeping and preventing most foods from being lodged under the installed dental appliance.

11. A dental protective device comprising:
a protective strip, the protective strip configured as a polyethylene base material coated with a water soluble adhesive coating on a dental appliance contacting side of the protective strip,
a backing strip loosely adhered to the dental appliance contacting side of the protective strip,
wherein the protective strip is capable of adhering to an installed dental appliance by the water soluble adhesive being exposed to moisture,
wherein the installed dental appliance is orthodontic braces.

12. The dental protective device of claim 11, wherein the dental protective device is supplied in a sealed foil pouch.

13. The dental protective device of claim 11, wherein the protective strip is capable of remaining adhered to the installed dental appliance during eating, drinking and sleeping.

14. A method of using a dental protective device, the dental protective device capable of protecting a wearer's lips, inside cheek and gums of an installed dental appliance from rough and sharp edges of the installed dental appliance, the method comprising:
a) trimming the dental protective device to a desired shape for use in covering a desired area of the installed dental appliance,
b) separating a backing strip from a protective strip of the dental protective device,
c) moistening the desired area surrounding an installed dental appliance to facilitate adhesion of the protective strip,
d) installing the protective strip in the desired area to an installed position,
e) the installed protective strip is then capable of being worn during eating, drinking and sleeping,
f) the installed protective strip is capable of being easily removed when a wearer's teeth require cleaning, and
g) installing a new protective strip after cleaning to the installed position.

15. The method of using the dental protective device of claim 14, wherein the protective device is capable of being installed in the desired area to the installed position by the following steps:
a) grasping the protective strip between fingers of the wearer of the protective strip and inserting the protective strip into a mouth of the wearer of the protective strip,
b) applying a first edge of the protective strip to a gum line of the desired area needing protection,
c) applying the protective strip over the desired area of the installed dental appliance,
d) wrapping the protective strip over a bottom edge and a back portion of the desired area,
e) rubbing with the wearer's fingers the installed protective strip, particularly proximal the installed dental appliance and at edges of the protective strip to ensure proper adhesion of a water soluble adhesive on the protective strip, and to reduce the size of the protective strip.

16. The method of using the dental protective device of claim 14, wherein installed dental appliance is orthodontic braces.

17. The method of using the dental protective device of claim 14, wherein the protective strip is capable of remaining adhered to the installed dental appliance while eating, drinking and sleeping and preventing most foods from being lodged under the installed dental appliance.

18. The method of using the dental protective device of claim 14, wherein the protective strip is configured as a base material coated with a water soluble adhesive coating on a dental appliance contacting side of the protective strip.

19. The method of using the dental protective device of claim 18, wherein the protective strip base material is polyethylene and the backing strip material is polypropylene.

20. The method of using the dental protective device of claim 14, wherein the protective strip is capable of being worn when a wax dental impression is being made of a wearer's teeth, and the worn protective strip is capable of preventing dental prevention wax from being lodged under the wearer's teeth.
